(19) United States
(12) Patent Application Publication
(10) Pub. No.: US 2022/0070565 A1
(43) Pub. Date: Mar. 3, 2022

(54) HEADPHONE ADAPTED TO PROVIDE IMPROVED PERFORMANCE AND COMFORT FOR EYEGLASS WEARERS

(71) Applicant: HED Technologies Sarl, Geneva (CH)

(72) Inventors: John Timothy Degraye, Geneva (CH); Liliane Huguet, Geneva (CH); Loic Huguet, Geneva (CH)

(73) Assignee: HED Technologies Sarl, Geneva (CH)

(21) Appl. No.: 17/104,720

(22) Filed: Nov. 25, 2020

Related U.S. Application Data
(60) Provisional application No. 63/072,017, filed on Aug. 28, 2020.

(51) Int. Cl. H04R 1/02; H04R 1/10

(52) U.S. Cl. CPC H04R 1/028; H04R 1/1066; H04R 1/1008

(57) ABSTRACT

A headphone, comprises a band; and left and right cup assemblies coupled to the band, the left cup assembly including a left donut-shaped cushion, the left donut-shaped cushion including a first left cushion portion and a second left cushion portion, the second left cushion portion being softer than the first left cushion portion and positioned at a left eyeglasses temple position, the right donut-shaped cushion including a first right cushion portion and a second right cushion portion, the second right cushion portion being softer than the first right cushion portion and positioned at a right eyeglasses temple position.

### CROSS REFERENCE TO RELATED APPLICATIONS

The present application claims the benefit of U.S. Provisional Patent Application Ser. No. 63/072,017 filed Aug. 28, 2020, entitled “Headphone Adapted To Provide Improved Performance And Comfort For Eyeglass Wearers,” which is hereby incorporated by reference herein.

### TECHNICAL FIELD

This disclosure pertains to wired or wireless headphones, and in some embodiments to headphones configured to provide improved performance and comfort for users who wear eyeglasses.

### BACKGROUND

Headphones come in a wide range of shapes, sizes, and types. Variations in headphone shape, size, type and/or function may dictate the manner in which the headphone is worn by a user, its comfort, and the extent to which ambient noise is blocked by the headphone.

Example headphone types include on-ear headphones, over-ear headphones, in-ear headphones, earbuds, and so forth. On-ear and over-ear headphones include ear cup cushions designed to rest on or over the ears of a user. Use of on-ear or over-ear headphones can sometimes lead to discomfort. Further, on-ear or over-ear headphones may cause greater discomfort for certain types of users.

### SUMMARY

Conventional headphones are available in a variety of shapes, sizes, types and configurations. A particular category of headphones includes headphones with ear cup assemblies that are connected to opposing ends of a headband and that are designed to sit on or over a user's ears.

While on-ear and over-ear headphones may provide more comfort and/or better performance to some users than in-ear headphones and earbuds, prolonged use of on-ear and over-ear headphones may cause discomfort for certain users, especially for those who wear eyeglasses (e.g., prescription eyeglasses, prescription or non-prescription sunglasses, reading glasses). In many cases, the ear cup cushions of the left and right ear cup assemblies of an on-ear or over-ear headphone put pressure on the left and right temples of a wearer's eyeglasses. The pressure translates the pressure on the eyeglasses temples to pressure the wearer's head and nose. This pressure, whether for a short or an extended period of time, may be quite uncomfortable. Further, because the ear cup cushions rest on the temples of the wearer's eyeglasses, the ear cup cushions do not create a good seal on or around the ear to support creation of a noise-isolating environment. In addition to allowing unwanted ambient sounds to be heard by the wearer, audio from the headphone speakers may exit the headphone and disturb those near the wearer.

Described herein are headphones adapted to provide eyeglass wearers with improved comfort and improved noise isolation.

In some embodiments, on-ear and over-ear headphones have ear cup assemblies with specialized cushion portions configured to better absorb the temples of the eyeglasses, to reduce pressure translated to the eyeglasses and thus to unpleasant points on the user's head and/or nose, and to improve creation of a noise-isolating environment around the user's ear. It will be appreciated that the teaching herein can be used to support users who wear any devices with extensions (e.g., temples) or components that cross and/or contact the ear cup cushions of one or both of the ear cup assemblies of a headphone. Although embodiments of the invention are described with regard to wearers of eyeglasses, the teaching herein may apply to embodiments used to support wearers of hearing aids, facial masks and/or the like.

In some embodiments, a headphone includes a headband that supports a left ear cup assembly on the left side and a right ear cup assembly on the right side. The left ear cup assembly includes a left ear cup cushion. The right ear cup assembly includes a right ear cup cushion.

In some embodiments, each of the left and right ear cup cushions includes a primary cushion portion and a second more receptive cushion portion. The primary cushion portion may be made from a first material adapted to contact the head of the user. The second more receptive cushion portion may be made from a second more receptive (softer) material that is adapted to accept and/or deflect around the temple of the wearer's eyeglasses (or other device). By deflecting around the temple of the eyeglasses, the second cushion portion exerts less pressure on the temples of the eyeglasses, thereby reducing the pressure translated by the glasses to the user's head and/or nose, and causes the primary cushion portions of the left and right ear cup assemblies and possibly parts of the second cushion portions of the left and right ear cup assemblies to contact the wearer's head to create a more noise-isolating environment.

In some embodiments, each of the first and second materials include foam with different softness characteristics. For instance, the second more receptive material of the second cushion portions may be softer than the first material of the primary cushion portions. Accordingly, the second cushion portions may be configured to deflect around and exert less force against the temples of the eyeglasses and may allow the left and right cushions to better contact the head to improve noise isolation. In this manner, the eyeglass wearer experiences enhanced comfort without sacrificing the “enclosed” fit of the headphone cushions.

In some embodiments, instead of including more receptive cushion portions in the left and right ear cup cushions, the left and right ear cup cushions may be configured with left and right temple channels adapted to receive the left and right temples of a user's eyeglasses. In some embodiments, the channels may be grooves. A groove may have any suitable shape, e.g., a concave cross section, a rectangular cross section, a triangular cross section, a cross section with curves and/or straight lines, and/or any other shaped cross section. The groove can be shaped to receive average-sized eyeglasses temples and/or may be designed to be stretchable/malleable to receive a range of different sizes and shapes of eyeglasses temples (plastic frames, metal frames, etc.). In some embodiments, the channels may be stretchable, displaceable, and/or depressable slits. Thus, when the temples of the eyeglasses are received by the slits, the side walls forming the slits may be stretched, displaced and/or depressed to receive the eyeglasses temples therein. Further, the opposing walls of the slits may apply a compressive force around the eyeglasses temples, thereby producing a more noise-isolating enclosure. In some embodiments, each slit may be defined by two substantially planar and/or curved surfaces.

In some embodiments, the present invention provides a headphone, comprising a band; and left and right cup assemblies coupled to the band, the left cup assembly including a left donut-shaped cushion, the left donut-shaped cushion including a first left cushion portion and a second left cushion portion, the second left cushion portion being softer than the first left cushion portion and positioned at a left eyeglasses temple position, the right donut-shaped cushion including a first right cushion portion and a second right cushion portion, the second right cushion portion being softer than the first right cushion portion and positioned at a right eyeglasses temple position.

The first left cushion portion and the first right cushion portion may comprise a first foam material, and the second left cushion portion and the second right cushion portion may comprise a second foam material different from the first foam material. The first foam material may have a first indentation force-deflection value and the second foam material may have a second indentation force-deflection value, the second indentation force-deflection value being less than the first indentation force-deflection value. The second left cushion portion and the second right cushion portion may each be positioned substantially horizontally when the headphone is worn by a user and the user is standing plumb and facing forward. Each of the left and right donut-shaped cushions may be encased in a cushion wrapping. Each of the left and right cup assemblies may include two second left cushion portions and two second right cushion portions. The two second left cushion portions may be positioned substantially horizontally when the headphone is worn by a user and the user is standing plumb and facing forward, and the two second right cushion portions may be positioned substantially horizontally when the headphone is worn by the user and the user is standing plumb and facing forward. The two second left cushion portions may include a front second left cushion portion and a rear second left cushion portion, the two second right cushion portions may include a front second right cushion portion and a rear second right cushion portion, the front second left cushion portion and the front second right cushion portion may be positioned substantially horizontally when the headphone is worn by a user and the user is standing plumb and facing forward, and the rear second left cushion portion and the rear second right cushion portion may be positioned lower than the front second left cushion portion and the front right cushion portion when the headphone is worn by the user and the user is standing plumb and facing forward. The left and right second cushion portions may extend an entire depth of the left and right donut-shaped cushions. The left and right second cushion portions may extend only a partial depth of the left and right donut-shaped cushions.

In some embodiments, the present invention provides a method of forming a headphone having left and right ear cup assemblies, comprising forming a left donut-shaped cushion, the left donut-shaped cushion including a first left cushion portion and a second left cushion portion, the second left cushion portion being softer than the first left cushion portion and positioned at a left eyeglasses temple position; forming a right donut-shaped cushion, the right donut-shaped cushion including a first right cushion portion and a second right cushion portion, the second right cushion portion being softer than the first right cushion portion and positioned at a right eyeglasses temple position; positioning the left donut-shaped cushion on a left ear cup assembly of the headphone; positioning the right donut-shaped cushion on a right ear cup assembly of the headphone.

The first left cushion portion and the first right cushion portion may comprise a first foam material, and the second left cushion portion and the second right cushion portion may comprise a second foam material different from the first foam material. The first foam material may have a first indentation force-deflection value and the second foam material may have a second indentation force-deflection value, the second indentation force-deflection value being less than the first indentation force-deflection value. The method may further comprise positioning each of the second left cushion portion and the second right cushion portion substantially along a horizontal plane when the headphone is worn by a user and the user is standing plumb and facing forward. The method may further comprise encasing each of the left and right donut-shaped cushions in a cushion wrapping. Each of the left and right cup assemblies may include two second left cushion portions and two second right cushion portions. The method may further comprise positioning the two second left cushion portions substantially on a horizontal plane when the headphone is worn by a user and the user is standing plumb and facing forward, and positioning the two second right cushion portions substantially on the horizontal plane when the headphone is worn by the user and the user is standing plumb and facing forward. The two second left cushion portions may include a front second left cushion portion and a rear second left cushion portion, the two second right cushion portions may include a front second right cushion portion and a rear second right cushion portion, and the method may further comprise positioning the front second left cushion portion and the front second right cushion portion substantially on a first horizontal plane when the headphone is worn by a user and the user is standing plumb and facing forward, and positioning the rear second left cushion portion and the rear second right cushion portion substantially on a second horizontal plane when the headphone is worn by the user and the user is standing plumb and facing forward, the second horizontal plane being lower than the first horizontal plane. The left and right second cushion portions may extend an entire depth of the left and right donut-shaped cushions. The left and right second cushion portions may extend only a partial depth of the left and right donut-shaped cushions.

These and other features of the apparatuses and methods disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1A is a front perspective view of a headphone that includes ear cup cushions configured to support eyeglass wearers, in accordance with some embodiments of the invention.

FIG. 1B is a front view of the headphone of FIG. 1A, in accordance with some embodiments of the invention.

FIG. 1C is a side view of the headphone of FIG. 1A in cooperation with eyeglasses, in accordance with some embodiments of the invention.

FIG. 1D is a front perspective view of a headphone configured to support eyeglass wearers, in accordance with some embodiments of the invention.

FIG. 2A is a front perspective view of a headphone that includes ear cup cushions configured to support eyeglass wearers, in accordance with some embodiments of the invention.

FIG. 2B is a front view of the headphone of FIG. 2A, in accordance with some embodiments of the invention.

FIG. 2C is a perspective view of the headphone of FIG. 2A in cooperation with eyeglasses, in accordance with some embodiments of the invention.

FIG. 3A is a perspective view of a headphone that includes ear cup cushions configured to support eyeglass wearers, in accordance with some embodiments of the invention.

FIG. 3B is a front view of the headphone of FIG. 3A, in accordance with some embodiments of the invention.

FIG. 3C is a perspective view of the headphone of FIG. 3A in cooperation with eyeglasses, in accordance with some embodiments of the invention.

FIG. 4 is a flowchart of a method of forming the headphone of FIGS. 1A-1C, in accordance with some embodiments of the invention.

FIG. 5 is a flowchart of a method of forming the headphone of FIGS. 2A-2C or of FIGS. 3A-3C, in accordance with some embodiments of the invention.

### DETAILED DESCRIPTION

Conventional headphones are available in a variety of shapes, sizes, types and configurations. A particular category of headphones includes headphones with ear cup assemblies that are connected to opposing ends of a headband and that are designed to sit on or over a user's ears.

While on-ear and over-ear headphones may provide more comfort and/or better performance to some users than in-ear headphones and earbuds, prolonged use of on-ear and over-ear headphones may cause discomfort for certain users, especially for those who wear eyeglasses (e.g., prescription eyeglasses, prescription or non-prescription sunglasses, reading glasses). In many cases, the ear cup cushions of the left and right ear cup assemblies of an on-ear or over-ear headphone put pressure on the left and right temples of a wearer's eyeglasses. The pressure translates the pressure on the eyeglasses temples to pressure the wearer's head and nose. This pressure, whether for a short or an extended period of time, may be quite uncomfortable. Further, because the ear cup cushions rest on the temples of the wearer's eyeglasses, the ear cup cushions do not create a good seal on or around the ear to support creation of a noise-isolating environment. In addition to allowing unwanted ambient sounds to be heard by the wearer, audio from the headphone speakers may exit the headphone and disturb those near the wearer.

Described herein are headphones adapted to provide eyeglass wearers with improved comfort and improved noise isolation.

In some embodiments, on-ear and over-ear headphones have ear cup assemblies with specialized cushion portions configured to better absorb the temples of the eyeglasses, to reduce pressure translated to the eyeglasses and thus to unpleasant points on the user's head and/or nose, and to improve creation of a noise-isolating environment around the user's ear. It will be appreciated that the teaching herein can be used to support users who wear any devices with extensions (e.g., temples) or components that cross and/or contact the ear cup cushions of one or both of the ear cup assemblies of a headphone. Although embodiments of the invention are described with regard to wearers of eyeglasses, the teaching herein may apply to embodiments used to support wearers of hearing aids, facial masks and/or the like.

In some embodiments, a headphone includes a headband that supports a left ear cup assembly on the left side and a right ear cup assembly on the right side. The left ear cup assembly includes a left ear cup cushion. The right ear cup assembly includes a right ear cup cushion.

In some embodiments, each of the left and right ear cup cushions includes a primary cushion portion and a second more receptive cushion portion. The primary cushion portion may be made from a first material adapted to contact the head of the user. The second more receptive cushion portion may be made from a second more receptive (softer) material that is adapted to accept and/or deflect around the temple of the wearer's eyeglasses (or other device). By deflecting around the temple of the eyeglasses, the second cushion portion exerts less pressure on the temples of the eyeglasses, thereby reducing the pressure translated by the glasses to the user's head and/or nose, and causes the primary cushion portions of the left and right ear cup assemblies and possibly parts of the second cushion portions of the left and right ear cup assemblies to contact the wearer's head to create a more noise-isolating environment.

In some embodiments, each of the first and second materials include foam with different softness characteristics. For instance, the second more receptive material of the second cushion portions may be softer than the first material of the primary cushion portions. Accordingly, the second cushion portions may be configured to deflect around and exert less force against the temples of the eyeglasses and may allow the left and right cushions to better contact the head to improve noise isolation. In this manner, the eyeglass wearer experiences enhanced comfort without sacrificing the “enclosed” fit of the headphone cushions.

In some embodiments, instead of including more receptive cushion portions in the left and right ear cup cushions, the left and right ear cup cushions may be configured with left and right temple channels adapted to receive the left and right temples of a user's eyeglasses. In some embodiments, the channels may be grooves. A groove may have any suitable shape, e.g., a concave cross section, a rectangular cross section, a triangular cross section, a cross section with curves and/or straight lines, and/or any other shaped cross section. The groove can be shaped to receive average-sized eyeglasses temples and/or may be designed to be stretchable/malleable to receive a range of different sizes and shapes of eyeglasses temples (plastic frames, metal frames, etc.). In some embodiments, the channels may be stretchable, displaceable, and/or depressable slits. Thus, when the temples of the eyeglasses are received by the slits, the side walls forming the slits may be stretched, displaced and/or depressed to receive the eyeglasses temples therein. Further, the opposing walls of the slits may apply a compressive force around the eyeglasses temples, thereby producing a more noise-isolating enclosure. In some embodiments, each slit may be defined by two substantially planar and/or curved surfaces.

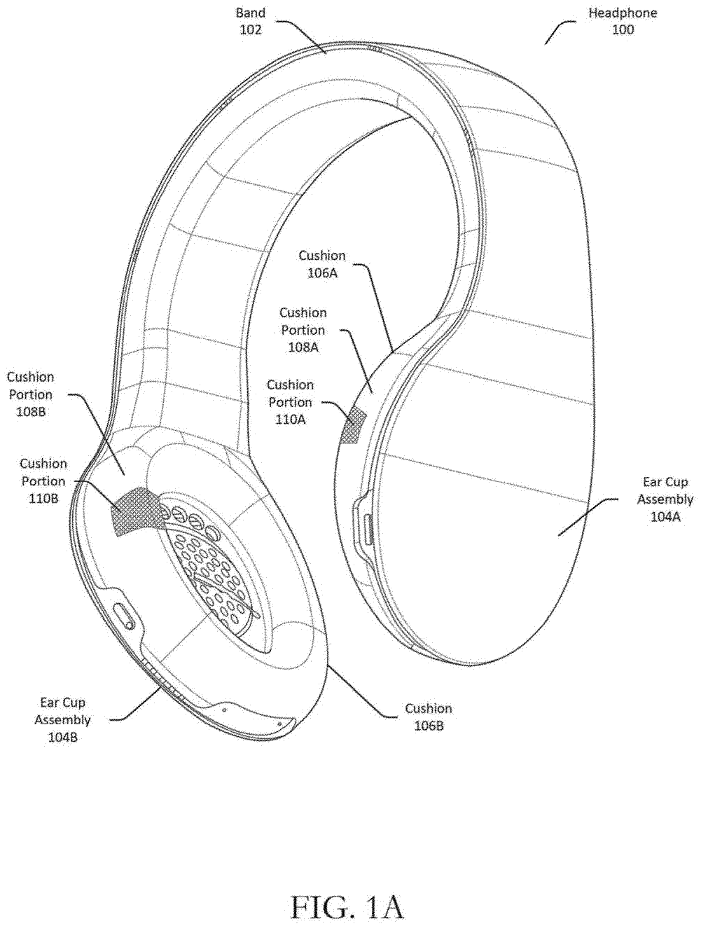

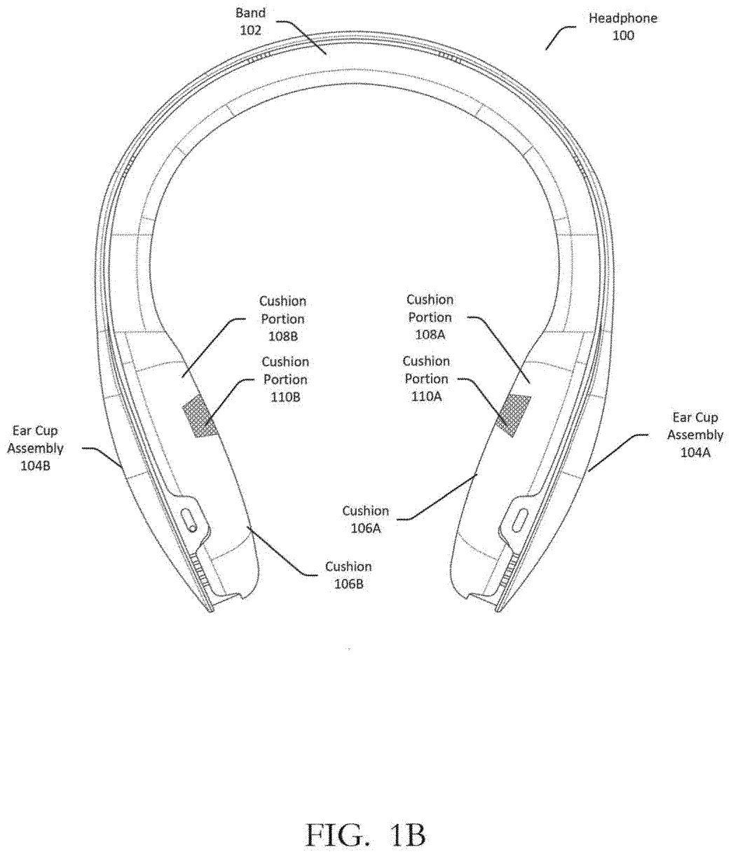

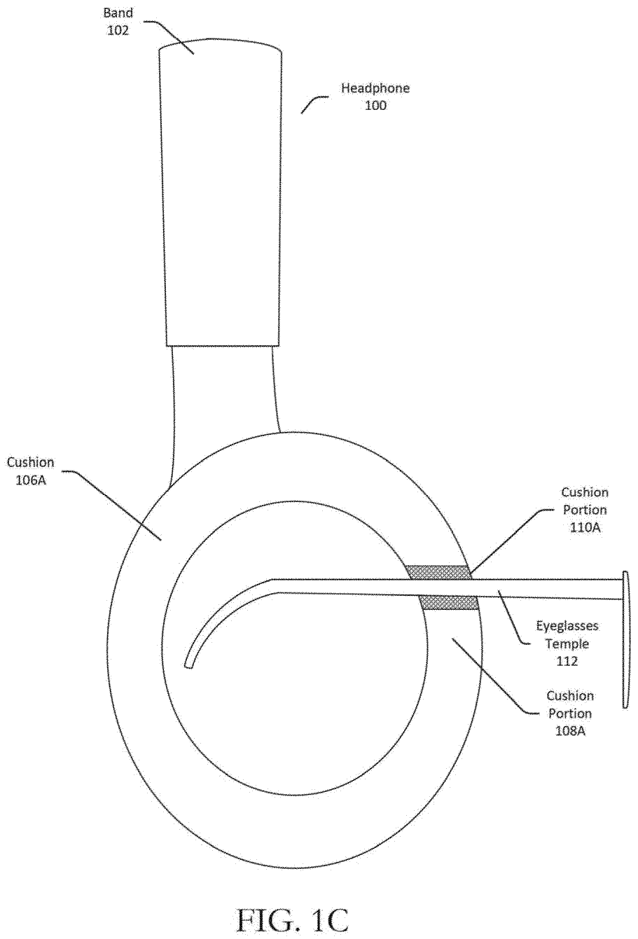

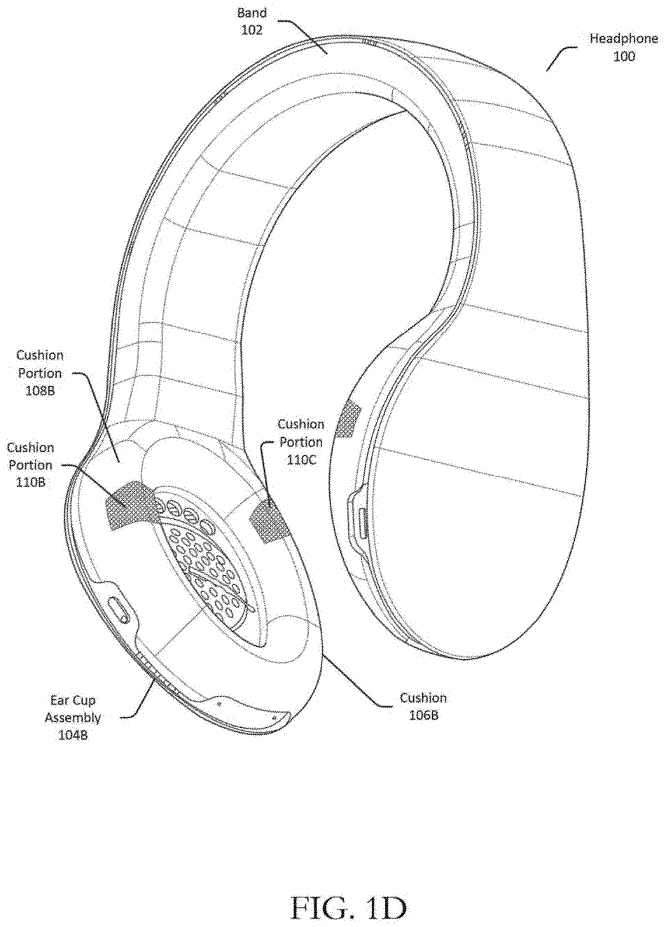

FIG. 1A depicts a front perspective view of a headphone 100 that includes a band 102 coupled to left and right ear cup assemblies 104A, 104B configured to enhance comfort for eyeglass wearers, in accordance with some embodiments of the invention. The left and right ear cup assemblies 104A, 104B include left and right ear cup cushions 106A, 106B, respectively. Each of the left and right ear cup cushions 106A and 106B includes a primary cushion portion formed of a first material and a second more receptive cushion portion formed of a second material. As indicated above, the second cushion portion may be softer than the first cushion portion.

In some embodiments, the band 102 that is configured to extend over the head of the user and to support the left ear cup assembly 104A at one end and the right ear cup assembly 104B at the other end. The band 102 may be integrally formed with the first and second ear cup assemblies 104A, 104B or coupled to the first and second eat cup assemblies 104A, 104B via one or more mechanical couplings. The band 102 is typically flexible to allow for the headphone 100 to be placed on and removed from a user's head. In some embodiments, the band 102 include a band cushion on an under side of the band 102 to add comfort when worn.

It should be appreciated that different sizes and/or types of the headphone 100 can embody the invention. For instance, the headphone 100 may be an on-ear headphone 100 or an over-ear headphone 100. The band 102 may be designed to rest on the top of the wearer's head, around the back side of the neck, around the front side of the neck, or elsewhere when in use. In some embodiments, the headphone 100 may include no band 102, and instead may include connecting structures such as ear clips to retain the left and right ear cup assemblies on or over the wearer's ears. In some embodiments, there may be only one ear cup assembly, e.g., a left ear cup assembly 104A or a right ear cup assembly 104B.

In some embodiments, the left ear cup assembly 104A includes a left cushion 106A, and the right ear cup assembly 104B includes a right cushion 106B. The left cushion 106A may be affixed to an inside surface of the left ear cup assembly 104A. Similarly, the right cushion 106B may be affixed to an inside surface of the right ear cup assembly 104B. In some embodiments, each of the left cushion 106A and the right cushion 106B may be “donut-shaped.” Although described as “donut” shaped, it will be appreciated that the shape need not be toric. In other words, the outer and/or inner perimeter of the left and right cushions 106A, 106B need not be circular, ovoid, or even curved. The perimeter can be diamond, polygonal and/or a combination of curved and linear sides.

As shown, each of the left and right ear cup cushions 106A, 106B may have a back surface configured to flush mount to the inside wall of its respective ear cup assembly 104A, 104B. The left and right ear cup cushions 106A and 106B may have a cross-sectional portion (opposite from the back surface) that may be curved, elliptical, polygonal, or the like. The cross section need not be consistent around the entire left and right ear cup cushions 106A, 106B. In some embodiments, the width of the cross section of the left and right ear cup cushions 106A, 106B may be approximately or less than 1″. In some embodiments, the depth of the cross section of the left and right cushions 106A, 106B may be approximately or less than 1″.

The second more receptive cushion portions 110A, 110B may include a height of approximately 1″ of the perimeter of the ear cup cushion (whether measured at the outer perimeter, inner perimeter or the midpoint therebetween of the left and right ear cup cushions 106A, 106B). The second more receptive cushion portions 110A, 110B may include a depth of approximately 0.5″ (measured at the midpoint between the inner and outer perimeters of the left and right ear cup cushions 106A, 106B). In some embodiments, the depth of the second more receptive cushion portions 110A, 110B may be selected to be approximately the distance between the outer side of the eyeglasses temples and the head of the user including any gap between the inner side of the eyeglasses temples and the head of the user, at the position of contact. In some embodiments, the depth may be selected within the range of 0.25″ and 0.75″. In some embodiments, each of the left and right second cushion portions 110A, 110B include the entire depth of the cushion 106A, 106B. In other words, the left and right second cushion portions may include 1″ tall segments of the and right cushions 106A, 106B.

In some embodiments, the left and right ear cup cushions 106A, 106B may include a cushion wrapping that encases the foam materials therein. The cushion wrapping may be made of stretchable fabric, leather, fake leather, and/or other material(s).

In some embodiments, the primary cushion portion 108A, 108B may include a higher density (stiffer) foam than the foam of the second cushion portion 110A, 110B. In other words, the indentation force-deflection value of the second material may be selected to be lower than the indentation force deflection value of the first material using, which can be calculated for example using a standard established in the flexible foam manufacturing industry to assess the softness/firmness of a sample of foam.

Referring to FIGS. 1A, 1B and 1C, the second cushion portions 110A, 110B may be positioned at locations on the left and right ear cup cushions 106A, 106B where the eyeglasses temples 112 extend when worn by the user. As shown, the second cushion portions 110A, 110B extend across the left and right ear cup cushions 106A, 106B from an outer perimeter to an inner perimeter “horizontally”. Notably, the direction is not necessarily radial, but rather horizontal to the ground plane when worn by the user and the user is standing plumb and facing forward. The horizontal position on the left and right ear cup cushions 106A, 106B is at a vertical position where the eyeglasses temples are likely pass (referred to herein as “temple position”). Notably, the first cushion portion 110A on the left ear cup assembly 104A is a mirror image of the second cushion portion 110B on the right ear cup assembly 104B. The band 102 may include conventional extenders to support positioning the second cushion portions 110A, 110B at the particular user's temple positions.

FIG. 1B depicts a front view of the headphone 100. As shown, the second cushion portion 110A, 110B may extend only partially into the respective cushion 106A, 106B. That is, in some embodiments, the second material need not be provided through an entire depth of the left and right ear cup cushions 106A, 106B. However, in some embodiments, the second resilient material may go the entire depth.

FIG. 1D depicts a front perspective view of the headphone 100, in accordance with some embodiments in which multiple second cushion portions 110A, 110B are positioned at front and rear portions of the ear cup cushions 106A, 106B. In some embodiments, e.g., on-ear headphones, it may be preferable to have two softer cushion portions to receive proximal and distal parts of the eyeglasses temples, since the eyeglasses temples may extend beyond the back side of the headphone cushions. The position of the front second cushion portion 110A, 110B may be along the same horizontal position as the rear second cushion portion 110C (shown), 110D (not shown, but mirror image to 110C on the left ear cup cushion) when worn by the user and the user is standing plumb and facing forward. As with the front second cushion portion 110A, 110B, the rear second cushion portion 110C, 110D may be formed of the second material. In some embodiments, when the headphone 100 is worn by an eyeglasses wearer, the rear ear cup cushion portions 110C, 110D may contact other portions of eyeglass temples that extend beyond the user's ear, e.g., the temple tips. In some embodiments, the position of the rear second cushion portion 110C, 110D may be lower than the temple position. In some embodiments, the rear second cushion portions 110C, 110D may not be horizontally directed, but instead may be angled “downwardly” as conventional temple tips.

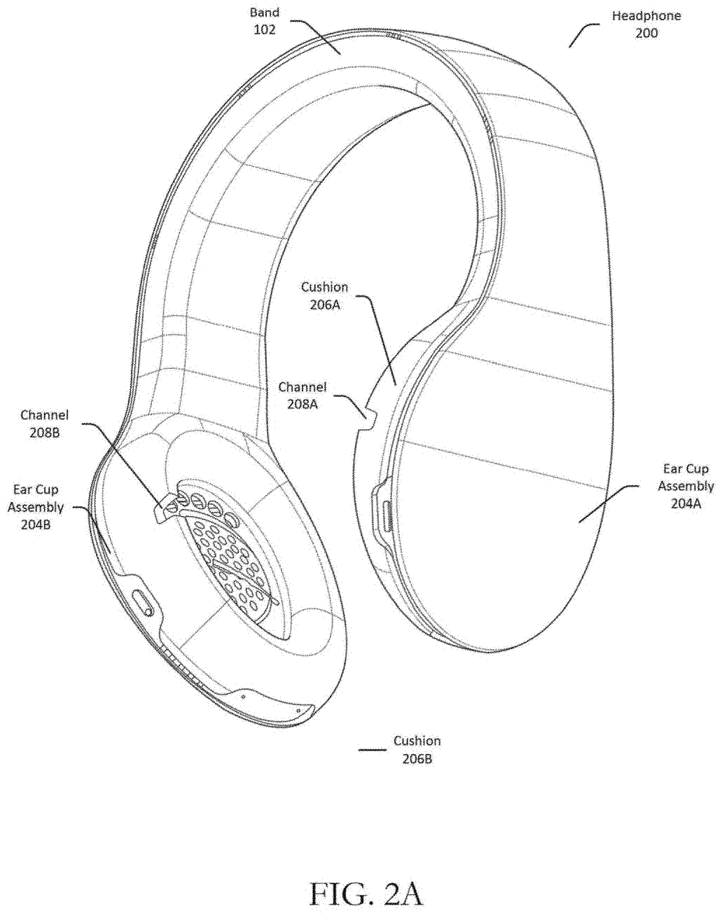

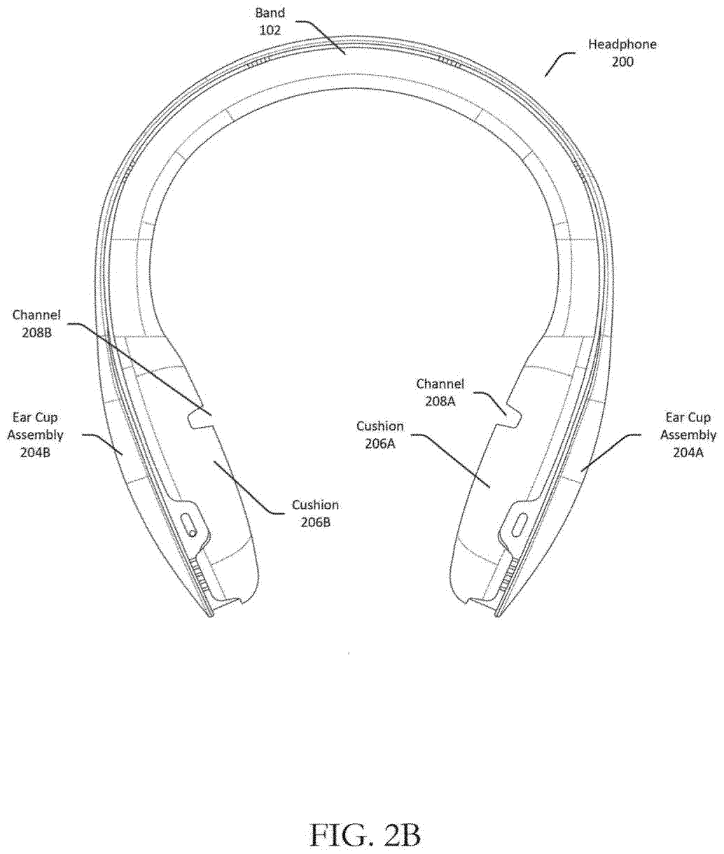

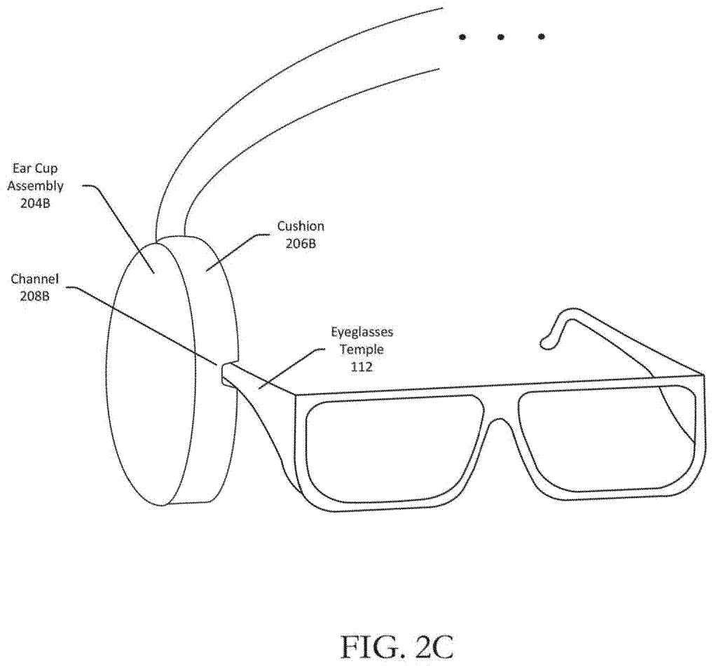

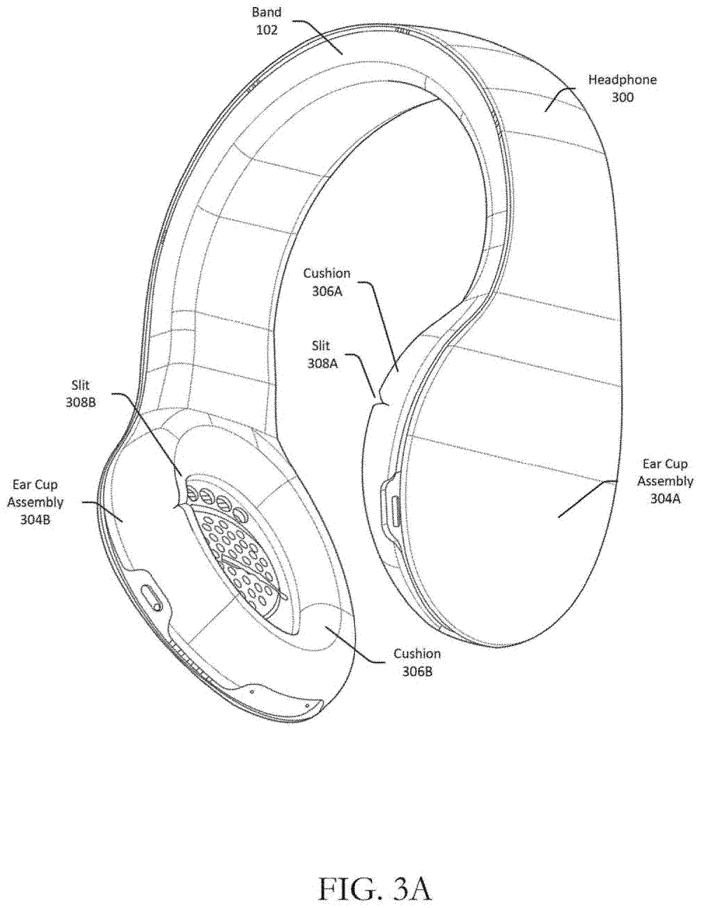

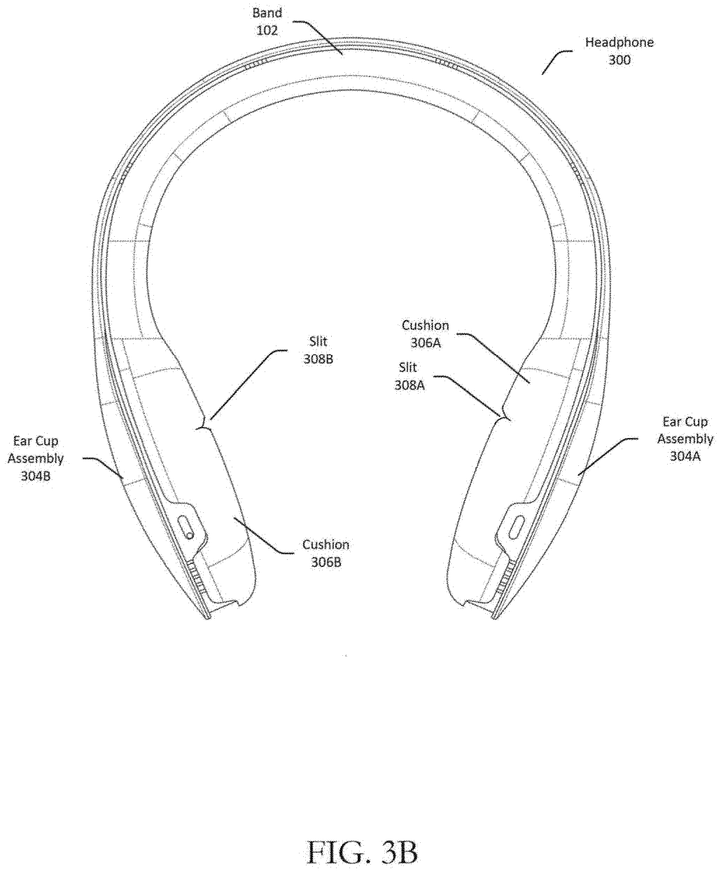

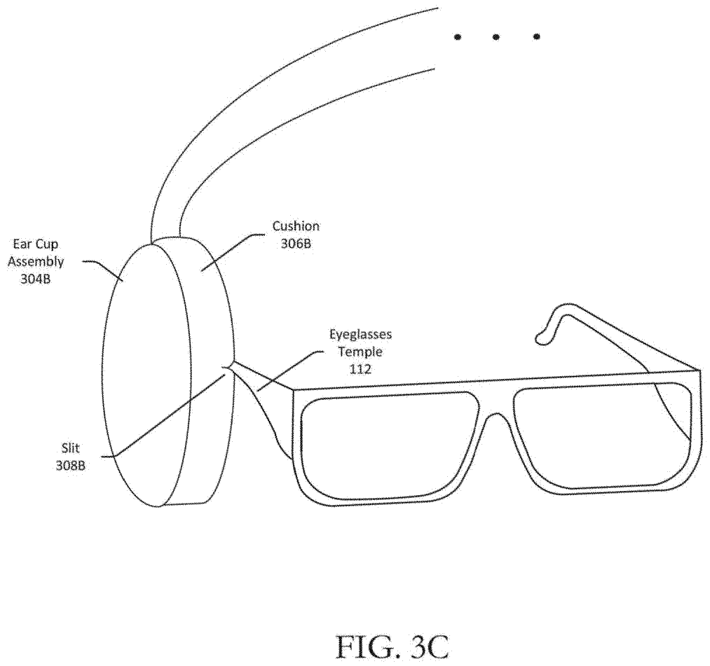

FIGS. 2A-2C and 3A-3C depict headphones that include left and right ear cup cushions with structures adapted to provide improved comfort and/or enhanced performance for eyeglass wearers, in accordance with some embodiments. More specifically, FIGS. 2A-2C and 3A-3C depict headphones with channels configured to receive the eyeglasses temples.

FIG. 2A depicts a front perspective view of a headphone 200 with channels formed as “grooves”, in accordance with some embodiments. While depicted as an over-ear type headphone, the headphone 200 may be of any shape, size, and/or type described herein (e.g., an on-ear headphone). The headphone 200 includes a band 102 for supporting a left ear cup assembly 204A and a right ear cup assembly 204B. As mentioned above, embodiments without a band 102 are possible. As described in relation to the headphone 100, the left and right ear cup assemblies 204A, 204B may be integrally formed with the band 102 or coupled to the band 102 via one or more mechanical couplings.

The left and right ear cup assemblies 204A, 204B include left and right ear cup cushions 206A, 206B. The left and right ear cup cushions 206A, 20BB includes left and right channels 208A, 208B. The left and right channels 208A, 208B may be adapted to receive the left and right eyeglasses temples. The left and right channels 208A, 208B may be grooves, troughs, or any other suitable type of indentation capable of receiving eyeglasses temples.

The shape of the left and right ear cup cushions 206A, 206B of the headphone 200 may be the same as the left and right cushions 106A, 106B of the headphone 100. The channels 208A, 208B may have a cross section of any shape, including curved, triangular, square, rectangular, etc. In some embodiments, the left channel 208A may have a different shape/contour than the right channel 208B. The width of each of the left and right channels 208A, 208B may be approximately 0.3″ to receive average-sized eyeglasses temples. The depth of the channels 208A, 208B may be approximately 0.5″ to accommodate the distance from the outer side of the temples and the head of the user. The depth of the channel may be between 0.25″ and 0.75″. In some embodiments, each of the left and right channels 208A, 208B may be formed through the entire cushion 206A, 206B.

FIG. 2B depicts a front view of the headphone 200, showing more plainly the left and right channels 208A, 208B as having a width and a depth.

FIG. 2C depicts the channel 208B in cooperation with an eyeglass temple 210. As shown, the channels 208A, 208B are positioned horizontally at the temple positions. Notably, the direction is not necessarily radial, but rather horizontal to the ground plane when worn by the user and the user is standing plumb and facing forward. Notably, the left channel 208A on the left ear cup assembly 204A is a mirror image of the right channel 208B on the right ear cup assembly 204B. The band 102 may include conventional extenders to support positioning the left and right channels 208A, 208B at the particular user's temple positions.

As mentioned with regard to FIG. 1D, headphone 200 may include additional channels to address additional temple portions, such as the temple tips.

FIG. 3A depicts a front perspective view of a headphone 300, in accordance with some embodiments. While depicted as an over-ear type headphone, the headphone 300 may be of any shape, size, and/or configuration described herein (e.g., an on-ear headphone). The headphone 300 may be just like headphone 200, except that instead of a groove-like channel 208A, 208B, the left and right cushions include slits 308A, 308B. The left and right slits 308A, 308B may be adapted to receive more securely the left and right eyeglasses temples.

The headphone 300 may include a first cup assembly 304A coupled via a band 102 to a second cup assembly 304B. As described earlier, the left and right ear cup assemblies 304A, 304B may be integrally formed with the band 102 or coupled to the band 102 via one or more mechanical couplings.

Each slit may be defined by two interior surfaces of the left and right ear cup cushions 306A, 306B that meet together. In some embodiments, the two interior surfaces may flexibly displace to receive the eyeglasses temples. In some embodiments, each slit 308A, 308B may have a depth of 0.5″. In some embodiments, each slit 308A, 308B may have a depth within the range of 0.25″ and 0.75″. In some embodiments, each of the left and right slits 308A, 308B may be formed through the entire cushion 306A, 306B.

FIG. 3B depicts a front view of the headphone 300, in accordance with some embodiments. As shown, the left and right slits 308A, 308B may extend partly through the left and right ear cup cushions 306A, 306B. A slit may be formed to only that depth needed to accommodate the distance from the outer side of the eyeglasses temples to the user's head. In some embodiments, the left and right slits 308A, 308B may extend through the entire depth of the left and right cushions 306A, 306B. As shown, the slits 308A, 308B are positioned horizontally at temple position. Notably, the direction is not necessarily radial, but rather horizontal to the ground plane when worn by the user and the user is standing plumb and facing forward. Notably, the left slit 308A on the left ear cup assembly 304A is a mirror image of the right slit 308B on the right ear cup assembly 304B. The band 102 may include conventional extenders to support positioning the left and right slits 308A, 308B at the particular user's temple positions.

As mentioned with regard to FIG. 1D, headphone 300 may include additional slits to address additional temple portions, such as the temple tips.

FIG. 3C shows the right slit 308B snugly receiving an eyeglass temple 310. In some embodiments, when a left or right slit 308A, 308B receives an eyeglass temple, the slit 308A, 308B applies a gentle compressive force to the eyeglass temple to improve creation of a noise-isolating environment.

Similar to that shown in FIG. 1D, as indicated above, additional channels (grooves, slits, etc.) may be formed at different locations on each ear cup cushion, e.g., to accommodate distal portions of the eyeglass temple, e.g., other points of the temple at the same horizontal position or at a lower position to accommodate other eyeglass parts such as the temple tips. As indicated above, this may be especially important with on-ear headphones.

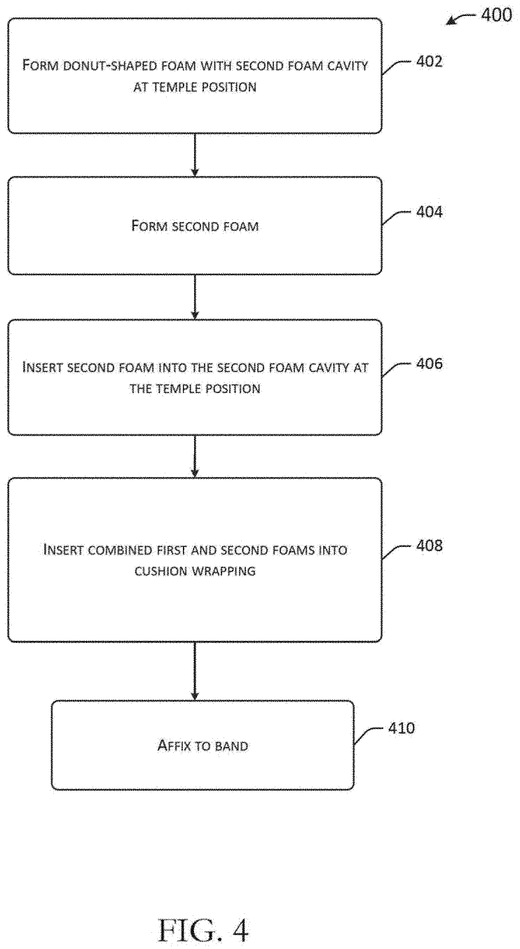

FIG. 4 is a flowchart of a method of forming the headphone 100 depicted in FIGS. 1A-1C, in accordance with some embodiments.

At block 402, a donut-shaped foam with a foam cavity is formed at the temple position. The foam cavity may be sized and shaped to receive a second foam of substantially the same size and shape therein. The donut-shaped foam may include a first material associated with a firmer characteristic having higher indentation force-deflection value. In some embodiments, the donut-shaped foam may be formed without the foam cavity and then the foam may be removed from the donut-shaped foam at the temple position to form the foam cavity. In some embodiments, the foam may be formed with the foam cavity.

At block 404, the second foam is formed with the same shape as the foam cavity. The second foam may be made of a second material associated with a softer characteristic (having a lower indentation force-deflection value) than the first material.

At block 406, the second foam is inserted into the foam cavity of the donut-shaped foam at the temple position. In some embodiments, the second foam may be formed directly into the foam cavity. In some embodiments, the second foam may be formed externally and then affixed into the cavity using glue or other known processes. In some embodiments, the second foam is only positioned therein with being affixed.

At block 408, the combined first and second foams are inserted into a cushion wrapping. In some embodiments, the cushion wrapping includes stretchable fabric, leather, fake leather, etc.

At block 410, the wrapped first and second foams are affixed to the back wall of the ear cup assembly 104A, 104B, which is affixed to the band 102. In some embodiments, the donut-shaped foam can be affixed to the back wall of the ear cup assembly 104A, 104B, and the wrapping positioned thereon, such that the wrapped first and second foams are effectively affixed to the back wall of the ear cup assembly 104A, 104B.

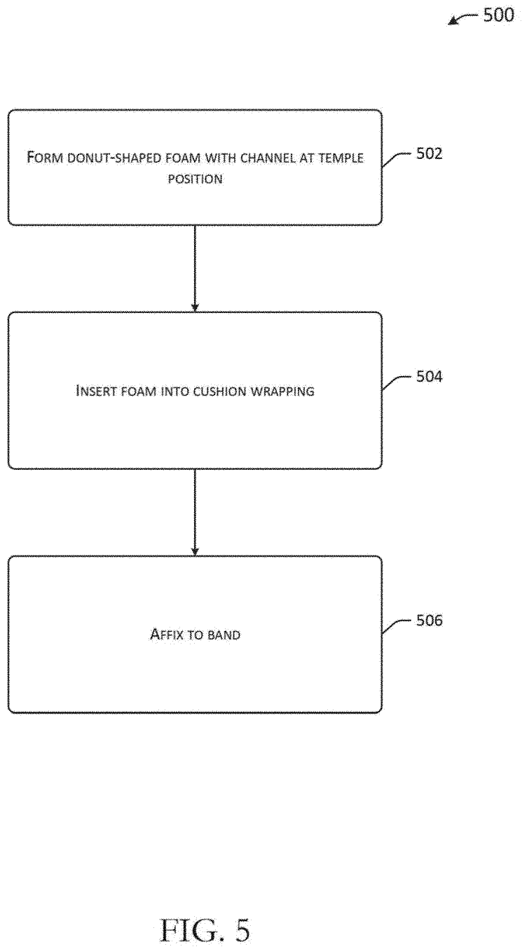

FIG. 5 is a flowchart of a method of forming the headphone depicted in FIGS. 2A-2C and/or the headphone depicted in FIGS. 3A-3C, in accordance with some embodiments.

At block 502, a donut-shaped foam with a channel at the temple position is formed. In some embodiments, the channel may be a groove as shown in FIGS. 2A-2C or a slit as shown in FIGS. 3A-3C. In some embodiments, the donut-shaped foam may be formed without the channel and then the foam may be removed from the donut-shaped foam at the temple position to form the channel. In some embodiments, the foam may be formed with the channel.

At block 504, the foam with the channel may be inserted into a cushion wrapping. In some embodiments, the cushion wrapping may be formed with a channel indentation that is positioned at the same location as the foam channel. In some embodiments, the cushion wrapping is stretchable, such that the cushion wrapping deflects where there is a foam channel by pressure of the eyeglasses temples.

At block 506, the wrapped foam is affixed to the back wall of the ear cup assembly 204A, 204B, 304A, 304B, which is affixed to the band 102. In some embodiments, the donut-shaped foam can be affixed to the back wall of the ear cup assembly 204A, 204B, 304A, 304B, and the wrapping positioned thereon, such that the wrapped foam is effectively affixed to the back wall of the ear cup assembly 204A, 204B, 304A, 304B.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made, and other embodiments may be used without departing from the broader scope of the present invention(s). Therefore, these and other variations upon the example embodiments are intended to be covered by the present invention(s).

1. A headphone, comprising:
a band; and
left and right cup assemblies coupled to the band, the left cup assembly including a left donut-shaped cushion, the left donut-shaped cushion including a first left cushion portion and a second left cushion portion, the second left cushion portion being softer than the first left cushion portion and positioned at a left eyeglasses temple position, the right donut-shaped cushion including a first right cushion portion and a second right cushion portion, the second right cushion portion being softer than the first right cushion portion and positioned at a right eyeglasses temple position.

2. The headphone of claim 1, wherein
the first left cushion portion and the first right cushion portion comprise a first foam material, and
the second left cushion portion and the second right cushion portion comprise a second foam material different from the first foam material.

3. The headphone of claim 2, wherein the first foam material has a first indentation force-deflection value and the second foam material has a second indentation force-deflection value, the second indentation force-deflection value being less than the first indentation force-deflection value.

4. The headphone of claim 1, wherein the second left cushion portion and the second right cushion portion each are positioned substantially horizontally when the headphone is worn by a user and the user is standing plumb and facing forward.

5. The headphone of claim 1, wherein each of the left and right donut-shaped cushions are encased in a cushion wrapping.

6. The headphone of claim 1, wherein each of the left and right cup assemblies include two second left cushion portions and two second right cushion portions.

7. The headphone of claim 6, wherein the two second left cushion portions are positioned substantially horizontally when the headphone is worn by a user and the user is standing plumb and facing forward, and the two second right cushion portions are positioned substantially horizontally when the headphone is worn by the user and the user is standing plumb and facing forward.

8. The headphone of claim 6, wherein the two second left cushion portions include a front second left cushion portion and a rear second left cushion portion, the two second right cushion portions include a front second right cushion portion and a rear second right cushion portion, the front second left cushion portion and the front second right cushion portion are positioned substantially horizontally when the headphone is worn by a user and the user is standing plumb and facing forward, and the rear second left cushion portion and the rear second right cushion portion are positioned lower than the front second left cushion portion and the front right cushion portion when the headphone is worn by the user and the user is standing plumb and facing forward.

9. The headphone of claim 1, wherein the left and right second cushion portions extend an entire depth of the left and right donut-shaped cushions.

10. The headphone of claim 3, wherein the left and right second cushion portions extend only a partial depth of the left and right donut-shaped cushions.

11. A method of forming a headphone having left and right ear cup assemblies, comprising:
forming a left donut-shaped cushion, the left donut-shaped cushion including a first left cushion portion and a second left cushion portion, the second left cushion portion being softer than the first left cushion portion and positioned at a left eyeglasses temple position;
forming a right donut-shaped cushion, the right donut-shaped cushion including a first right cushion portion and a second right cushion portion, the second right cushion portion being softer than the first right cushion portion and positioned at a right eyeglasses temple position;
positioning the left donut-shaped cushion on a left ear cup assembly of the headphone;
positioning the right donut-shaped cushion on a right ear cup assembly of the headphone.

12. The method of claim 11, wherein
the first left cushion portion and the first right cushion portion comprise a first foam material, and
the second left cushion portion and the second right cushion portion comprise a second foam material different from the first foam material.

13. The method of claim 12, wherein the first foam material has a first indentation force-deflection value and the second foam material has a second indentation force-deflection value, the second indentation force-deflection value being less than the first indentation force-deflection value.

14. The method of claim 11, further comprising positioning each of the second left cushion portion and the second right cushion portion substantially along a horizontal plane when the headphone is worn by a user and the user is standing plumb and facing forward.

15. The method of claim 11, further comprising encasing each of the left and right donut-shaped cushions in a cushion wrapping.

16. The method of claim 11, wherein each of the left and right cup assemblies include two second left cushion portions and two second right cushion portions.

17. The method of claim 16, further comprising positioning the two second left cushion portions substantially on a horizontal plane when the headphone is worn by a user and the user is standing plumb and facing forward, and positioning the two second right cushion portions substantially on the horizontal plane when the headphone is worn by the user and the user is standing plumb and facing forward.

18. The method of claim 16, wherein the two second left cushion portions include a front second left cushion portion and a rear second left cushion portion, the two second right cushion portions include a front second right cushion portion and a rear second right cushion portion, and further comprising positioning the front second left cushion portion and the front second right cushion portion substantially on a first horizontal plane when the headphone is worn by a user and the user is standing plumb and facing forward, and positioning the rear second left cushion portion and the rear second right cushion portion substantially on a second horizontal plane when the headphone is worn by the user and the user is standing plumb and facing forward, the second horizontal plane being lower than the first horizontal plane.

19. The method of claim 11, wherein the left and right second cushion portions extend an entire depth of the left and right donut-shaped cushions.

20. The method of claim 13, wherein the left and right second cushion portions extend only a partial depth of the left and right donut-shaped cushions.
